(19) United States
(12) Patent Application Publication
(10) Pub. No.: US 2024/0254934 A1
(43) Pub. Date: Aug. 1, 2024

(54) AIR COMPRESSOR OPERATION

(71) Applicant: Lincoln Global, Inc., Santa Fe Springs, CA (US)

(72) Inventors: Erik C. Miller, Mentor, OH (US); Adam K. Simon, South Euclid, OH (US)

(21) Appl. No.: 18/102,819

(22) Filed: Jan. 30, 2023

(51) Int. Cl. F02D 29/04; B23K 9/10; F04B 49/06; F04B 49/22

(52) U.S. Cl. CPC F02D 29/04; B23K 9/1006; F04B 49/065; F04B 49/225

(57) ABSTRACT

An engine driven welding system having an air compressor subsystem is provided. The system includes a first air pressure sensor to measure an outlet air pressure value at an outlet of the air compressor subsystem. A proportional air inlet valve device is configured to be adjusted to regulate the outlet air pressure value. A controller is configured to record an adjustment value of the proportional air inlet valve device as adjusted. A clutch mechanism is configured to be engaged to enable air compression, and to be disengaged by the controller when the adjustment value of the proportional air inlet valve falls below a first threshold value for a determined period of time. A second air pressure sensor is configured to monitor a second air pressure value, where the clutch mechanism cannot be re-engaged by the controller unless the second air pressure value falls below a second threshold value.

### REFERENCE

U.S. Pat. No. 7,105,774 issued on Sep. 12, 2006 is incorporated herein by reference in its entirety.

### FIELD

Embodiments of the present invention relate to multi-function machines having an air compressor. More specifically, embodiments of the present invention relate to multi-function machines having an air compressor integrated into an engine driven welder.

### BACKGROUND

Multi-function machines exist that are capable of providing welding, auxiliary power, battery charging/jumping, hydraulic pumping, and compressed air. Generally, a stand-alone air compressor powered by an engine likely has the engine sized to never get overloaded. However, multi-function machines often have the engine sized less than the combined output of the air compressor, the weld output, and the auxiliary output. This can lead to inefficiencies in use of the multi-function machine. One example of a conventional multi-function machine is disclosed in U.S. Pat. No. 7,105,774 issued on Sep. 12, 2006, which is incorporated herein by reference in its entirety.

### SUMMARY

Embodiments of multi-function machines (e.g., multi-function engine arc welding machines having an air compressor) with improved efficiency are provided by disengaging the clutch if it is determined no compressed air load has been required for a period of time, by varying the engine speed, or by varying the inlet valve on the air compressor. Such a multi-function machine may also provide capabilities for welding, auxiliary power, battery charging and/or jumping, and hydraulic pumping, for example. In one embodiment, an air compressor subsystem is an integral part of the multi-function machine and supports compressed air tool capabilities. The multi-function machine is configured to improve efficiency and account for the unique challenges when assembled as an engine driven welder.

One embodiment is an engine driven welding system having an air compressor subsystem. In one embodiment, the system includes a first air pressure sensor configured to measure an outlet air pressure value at an outlet of the air compressor subsystem. The system also includes a proportional air inlet valve device configured to be adjusted to regulate the outlet air pressure value. The system further includes at least one controller configured to record an adjustment value of the proportional air inlet valve device as adjusted. The system includes a clutch assembly or clutch mechanism configured to be engaged to enable air compression, and configured to be disengaged by the controller when the adjustment value of the proportional air inlet valve falls below a first threshold value for a determined period of time. The system also includes a second air pressure sensor configured to monitor a second air pressure value, where the clutch assembly cannot be re-engaged by the controller unless the second air pressure value falls below a second threshold value. In one embodiment, the system includes an oil/gas separator device, where the second air pressure sensor is mounted proximate the oil/gas separator device. In one embodiment, the proportional air inlet valve device includes a solenoid valve. In one embodiment, the controller is configured to control the proportional air inlet valve device. In one embodiment, the controller is configured to stop an engine of the engine driven welding system when conditions indicate inactivity over a second determined period of time. In one embodiment, the controller is configured to vary a speed of an engine of the engine driven welding system based on a demand of the air compressor subsystem. In one embodiment, the controller is configured to monitor a bus voltage to a weld circuit of the engine driven welding system and command the air compressor subsystem to reduce air output when the bus voltage drops below a bus voltage threshold value. In one embodiment, the controller is configured to monitor an electrical parameter of an auxiliary power provided by the engine driven welding system and command the air compressor subsystem to reduce air output when the electrical parameter drops below an associated threshold value. The electrical parameter may a voltage, a current, a power, or a frequency, for example.

One embodiment is a method of operating an air compressor subsystem of an engine driven welding system. The method includes measuring an outlet air pressure value at an outlet of an air compressor subsystem of an engine driven welding system. The method also includes adjusting a proportional air inlet valve device of the air compressor subsystem to regulate the outlet air pressure value. The method further includes recording an adjustment value of the proportional air inlet valve device based on the adjusting. The method also includes disengaging a clutch of an engine of the engine driven welding system when the adjustment value of the proportional air inlet valve device falls below a first threshold value for a determined period of time. The method further includes monitoring a second air pressure value, where the clutch cannot be re-engaged unless the second air pressure value falls below a second threshold value. In one embodiment, the second air pressure value is monitored proximate an oil/gas separator device of the air compressor subsystem. In one embodiment, the proportional air inlet valve device includes a solenoid valve. In one embodiment, the proportional air inlet valve device is controlled by a controller. In one embodiment, the method includes stopping an engine of the engine driven welding system when conditions indicate inactivity over a second determined period of time. In one embodiment, the method includes varying a speed of an engine of the engine driven welding system based on a demand of the air compressor subsystem. In one embodiment, the method includes monitoring a bus voltage to a weld circuit of the engine driven welding system and commanding the air compressor subsystem to reduce air output when the bus voltage drops below a bus voltage threshold value. In one embodiment, the method includes monitoring an electrical parameter of an auxiliary power provided by the engine driven welding system and commanding the air compressor subsystem to reduce air output when the electrical parameter drops below an associated threshold value. The electrical parameter may a voltage, a current, a power, or a frequency, for example.

Numerous aspects of the general inventive concepts will become readily apparent from the following detailed description of exemplary embodiments, from the claims, and from the accompanying drawings.

### BRIEF DESCRIPTION OF THE DRAWINGS

The accompanying drawings, which are incorporated in and constitute a part of the specification, illustrate various embodiments of the disclosure. It will be appreciated that the illustrated element boundaries (e.g., boxes, groups of boxes, or other shapes) in the figures represent one embodiment of boundaries. In some embodiments, one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates a first view of one embodiment of a multi-function machine having an air compressor subsystem;

FIG. 2 illustrates a second view of the multi-function machine of FIG. 1;

FIG. 3 illustrates a third view of the multi-function machine of FIG. 1;

FIG. 4 illustrates a fourth view of the multi-function machine of FIG. 1;

FIG. 5 illustrates a fifth view of the multi-function machine of FIG. 1;

FIG. 6 illustrates a system block diagram of the multi-function machine of FIGS. 1-5;

FIG. 7 illustrates a flowchart of one embodiment of a method performed by the multi-function machine of FIGS. 1-5; and

FIG. 8 illustrates a block diagram of an example embodiment of a controller that can be used in the multi-function machine of FIGS. 1-6.

### DETAILED DESCRIPTION

Embodiments of the present invention include multi-function machines having integral air compressors that support compressed air tools and processes. A multi-function machine may be capable of providing, for example, welding, auxiliary power, and compressed air. Some machines may also include a hydraulic pump capability, a battery charge/jump capability, and a means to power an HVAC system of a vehicle. As the capability of machines increase, attention to the efficiency of the machines is warranted. Ways in which the efficiency and operation of a multi-function machine can be improved is discussed herein with respect to welding, auxiliary power, and compressed air capabilities.

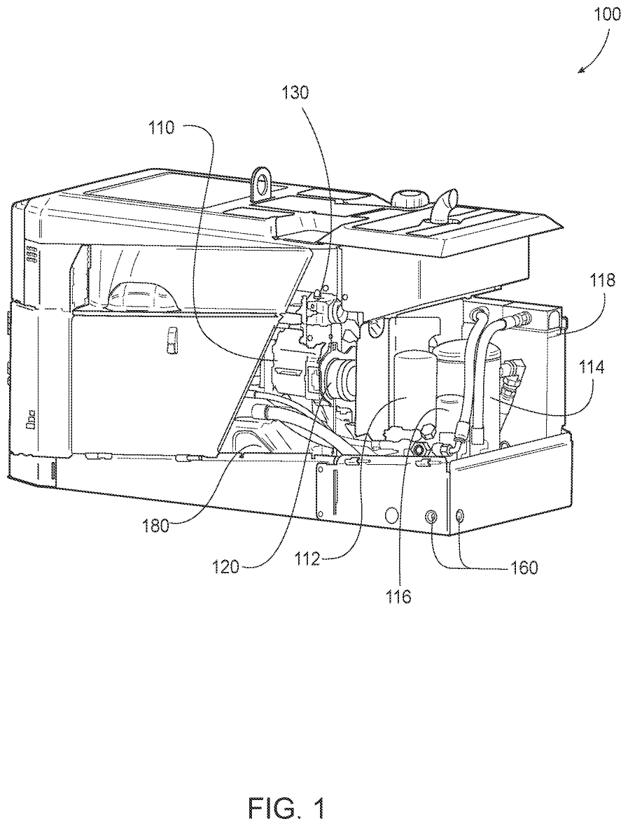

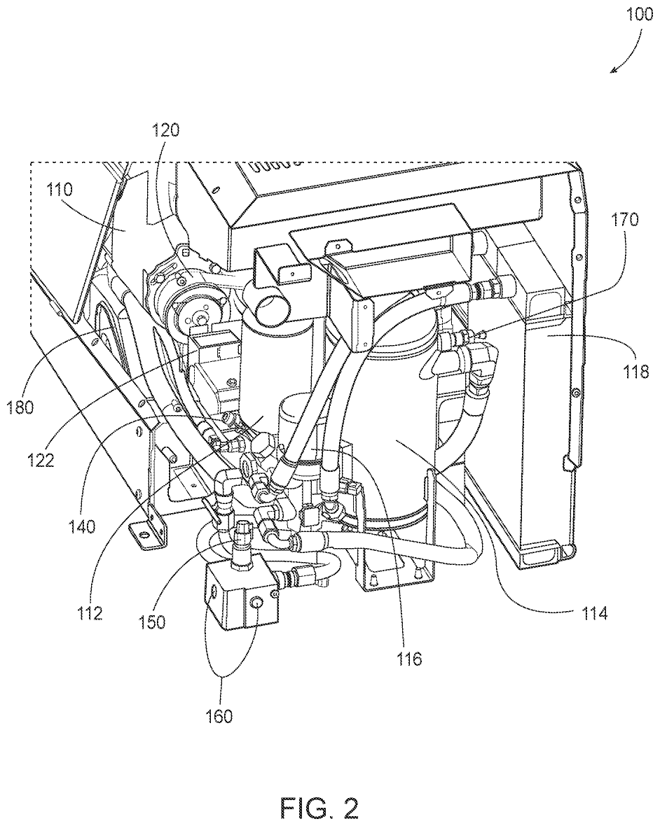

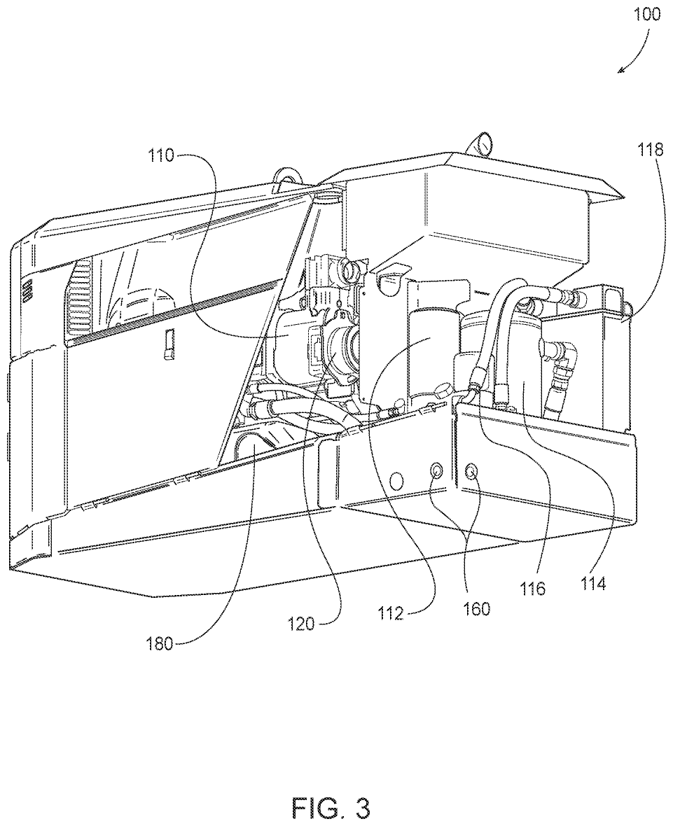

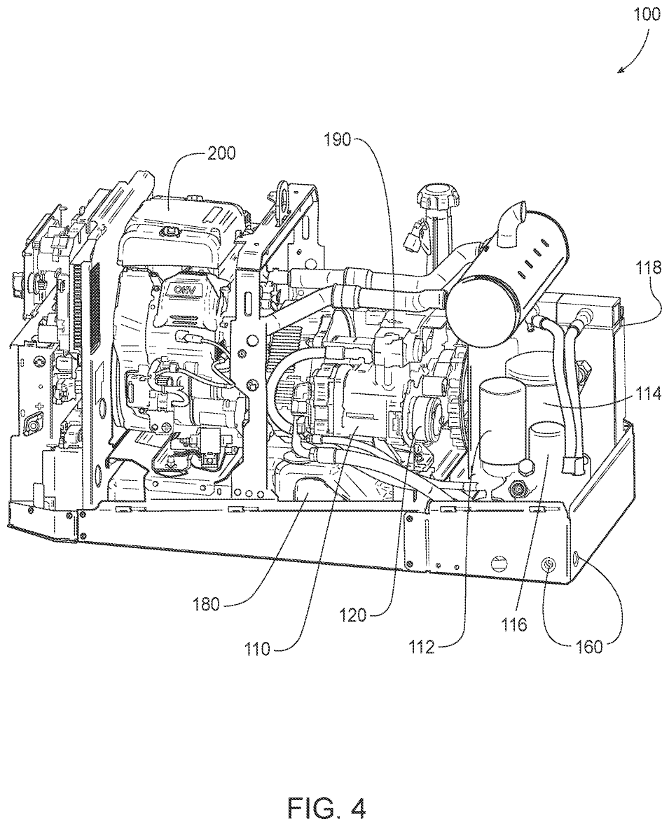

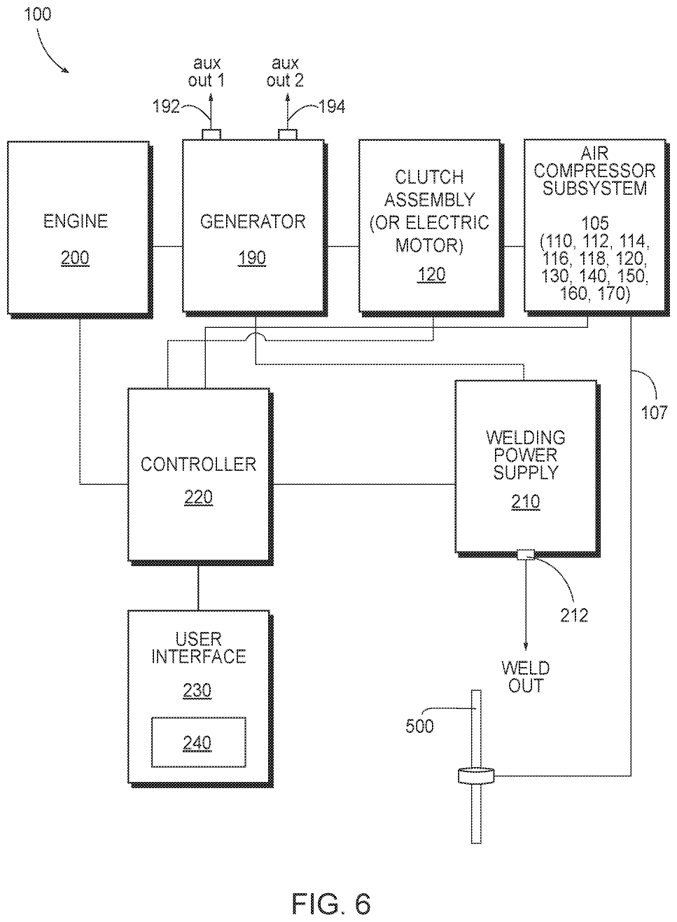

The examples and figures herein are illustrative only and are not meant to limit the subject invention, which is measured by the scope and spirit of the claims. Referring now to the drawings, wherein the showings are for the purpose of illustrating exemplary embodiments of the subject invention only and not for the purpose of limiting same, FIGS. 1-5 illustrate one embodiment of a multi-function machine, in the form of an engine-driven welding system (EDWS) 100, having an air compressor subsystem 105. FIG. 6 illustrates a system block diagram of the EDWS 100 of FIGS. 1-5 having an air compressor subsystem 105. The EDWS 100 provides arc welding capability, auxiliary power capability, and compressed air capability, in accordance with one embodiment. The overall maximum external dimensions of the EDWS 100 are about 22 inches wide by about 29 inches tall by about 48 inches long, in accordance with one embodiment. The various components of the EDWS 100, many of which are discussed herein, fit within those overall external dimensions. Other overall maximum external dimensions are possible as well, in accordance with other embodiments.

FIGS. 1-5 illustrate various views (or at least partial views) of one embodiment of the multi-function machine, in the form of the engine-driven welding system (EDWS) 100, having the air compressor subsystem 105. Referring to FIGS. 1-5, the air compressor subsystem 105 includes an air compressor 110, an oil/air tank assembly 114, an oil/gas separator device 112 (having a coalescing filter), an oil filter 116, and a cooler assembly 118. The air compressor subsystem 105 also includes a clutch assembly 120 (e.g., having a clutch and a belt assembly in one embodiment), an air inlet valve device 130, a sump pressure sensor 140 (a second air pressure sensor), an outlet air pressure sensor 150 (a first air pressure sensor), a customer air connection 160, and an overpressure valve 170.

The air inlet valve device 130 regulates an amount of air taken in by the air compressor 110. The valve of the air inlet valve device 130 closes when the desired air pressure is achieved within the compressor 110. No additional air is taken in and compressed when the desired air pressure level is achieved. In one embodiment, the valve of the air inlet valve device is a solenoid valve that controls air flow by opening/closing in response to a control signal. For example, in one embodiment, the air inlet valve device 130 is a proportional air inlet valve device that converts a variable current or voltage signal (control signal) into a proportional compressed air output. In one embodiment, the proportional air inlet valve device is restricted to a smaller range of operation, for example, for limiting power (limiting max output) or for de-rating the compressor (e.g., instead of 0%-100%, 0%-50%).

The clutch assembly 120 may include a clutch relay 122 which is controlled by a control circuit to engage and disengage a clutch of the clutch assembly 120. The EDWS 100 includes a fuel tank 180, a generator 190, and an engine 200. The engine 200 may be a gasoline or diesel fueled engine, for example. The fuel is stored in the refillable fuel tank 180. Other types of fuels may be possible as well, in accordance with other embodiments.

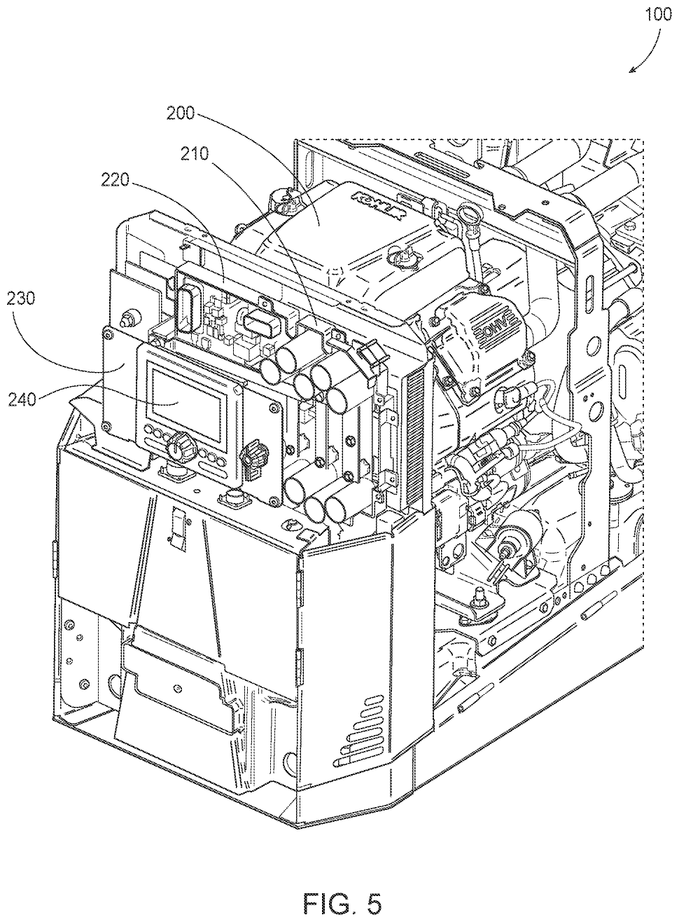

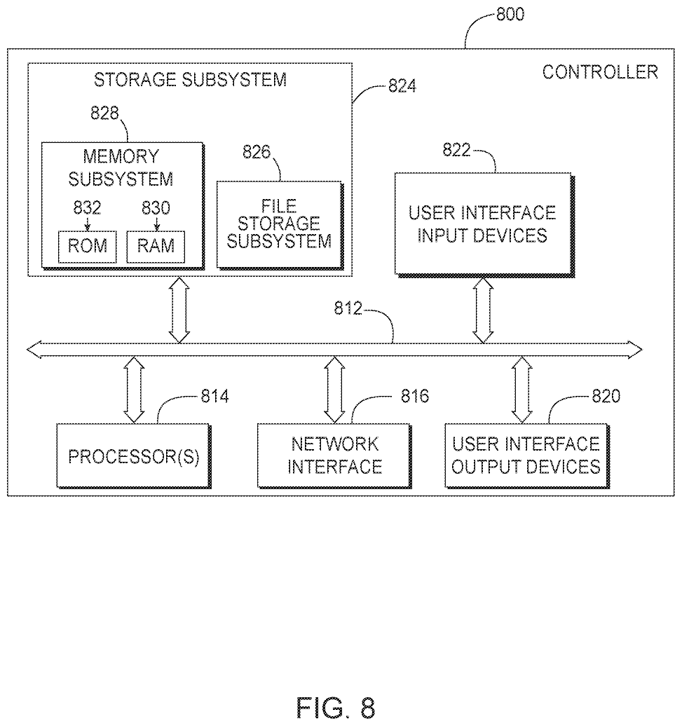

FIG. 5 illustrates one view of the EDWS 100 showing some of the same elements of FIGS. 1-4 as well as a welding power supply 210, a controller 220 (e.g., a control circuit), a user interface 230, and a digital display screen 240 of the user interface 230. The welding power supply 210 may be an inverter-based and/or a chopper-based welding power supply, for example, the technology of which is known in the art. The controller 220 may be the controller 800 discussed later herein with respect to FIG. 8, or some similar controller, in accordance with various embodiments. The user interface 230 may include, for example, switches, pushbuttons, and knobs and/or other similar types of devices for inputting information and making selections by communicating with the controller 220, in accordance with various embodiments. The user interface 230 may include some features of the controller 800 discussed in FIG. 8 with respect to the user interface input devices 822 and the user interface output devices 820. The digital display screen 240 may be, for example, an LCD display screen having touch screen capability in accordance with one embodiment, or a thin-film-transistor (TFT) display screen in accordance with another embodiment.

Referring to FIG. 6, in general, the engine 200 mechanically drives the generator 190. The generator 190 mechanically drives the air compressor 110 via the clutch assembly 120. The generator 190 also provides electrical power for at least the welding power supply 210. The controller 220 provides control logic and functionality to control at least the engine 200, the clutch assembly 120, the air compressor subsystem 105, and the welding power supply 210. The controller 220 is operatively connected to the user interface 230 to accept user commands and selections from the user interface 230 and to provide output information to the user interface 230. The generator 190 may also be used to provide electrical power to other parts of the EDWS 100 such as, for example, the controller 220 and the user interface 230. In accordance with an alternative embodiment, the engine 200 (instead of the generator 190) mechanically drives the air compressor system 105 via the clutch assembly 120.

In other embodiments, the controller 220 may be distributed among one or more of the engine 200, the generator 190, the air compressor subsystem 105, the welding power supply 210, or the user interface 230. For example, in one embodiment, one or more of the engine 200, the generator 190, the air compressor subsystem 105, the welding power supply 210, or the user interface 230 also include one or more components (e.g., control circuitry) of the controller 220 (e.g., elements of the controller 800 of FIG. 8). In this manner, multiple elements of the EDWS 100 may include at least some level of control capability.

Operation of the air compressor subsystem 105 is described next herein. Referring to FIGS. 1-5, in one embodiment, the air compressor 110 is a rotary screw compressor that accepts an air/oil mixture from the oil/air tank assembly 114 and compresses the air/oil mixture. The oil helps to seal microscopic gaps between the screws of the compressor 110 and also acts as a lubricant of the screws. The compressor 110 effectively takes a lower pressure air/oil input and outputs a higher pressure air/oil output. The higher pressure air/oil output enters the air/gas separator assembly 112 (which includes a coalescing filter) from the compressor 110, and separates the oil from the air. The compressing process adds energy which needs to be removed. The oil, after being separated from the air, is circulated through the cooler 118 (which acts as a radiator) before the oil is fed back to the oil/air tank assembly 114. In this manner, the tool receiving the compressed air output is protected from much of the heat produced by the compressor 110. Other types of cooling can be provided, in accordance with other embodiments.

Referring again to FIGS. 1-6, the clutch assembly 120 is operatively connected to an end of the generator 190 and driven (e.g., mechanically spun) by the generator 190. The clutch assembly 120 is located next to the air compressor 110 such that, for example, a belt of the clutch assembly 120 interfaces between the clutch assembly 120 and the air compressor 110. Therefore, the air compressor 110 is driven by the generator 190 via the clutch assembly 120, to produce a compressed air output 107 (at customer air connection 160) of the air compressor subsystem 105, when the clutch assembly 120 is engaged. In accordance with one embodiment, the clutch assembly 120 is engaged/disengaged via a control signal(s) from the controller 220 to the clutch assembly 120. The clutch assembly 120 may be disengaged from the compressor 110, for example, to turn the compressor off, or when the temperature of the compressor 110 becomes too high, or when the pressure produced by the compressor 110 becomes too high. For example, the compressor 110 may be cycled on and off (engaged/disengaged) such that the compressor 110 turns off when the pressure exceeds 120 psi and turns back on when the pressure drops below 80 psi, in accordance with one embodiment. Pressure and temperature sensors may be provided to measure the pressure and temperature of the compressor 110 during operation, and provide measurements of pressure and temperature back to the controller 220.

In accordance with an alternative embodiment, the clutch assembly 120 is replaced with an electric motor (not explicitly shown in FIGS. 1-5; however, see FIG. 6). In such an alternative embodiment, the electric motor is operatively connected between the generator 190 and the air compressor 110, and the air compressor 110 is driven by the generator 190 via the electric motor. That is, the generator 190 provides electricity to the electric motor, and the electric motor provides rotational motion to drive the air compressor 110. In yet another alternative embodiment, the electric motor is electrically driven by a battery (not shown) instead of the generator 190. In such alternative embodiments, the electric motor is engaged/disengaged via a control signal(s) from the controller 220 to the electric motor.

The battery is primarily used to provide electrical power to start the engine 200 but, in some alternative embodiments could also be used to provide electrical power to an electric motor operatively connected between the generator 190 and the compressor 110 as discussed above herein. In accordance with other embodiments, the battery could also be used to provide electrical power to other parts of the EDWS 100 such as, for example, the controller 220, the welding power supply 210, and the user interface 230. In accordance with one embodiment, electrical power from the generator 190 is used to recharge the battery. For example, AC electrical power from the generator 190 may be converted to DC electrical power by the welding power supply 210 and the DC electrical power from the welding power supply 210 is used to recharge the battery.

Referring again to FIG. 6, the welding power supply 210 receives electrical power from the generator 190 (and/or a battery) and is capable of producing an arc welding output 212. The generator 190 is capable of producing a first auxiliary power output 192 (e.g., 120 VAC) and a second auxiliary power output 194 (e.g., 24 VDC). In an alternative embodiment, the welding power supply 210 receives electrical power from the generator 190 (and/or a battery) and is capable of producing the first auxiliary power output 192 and the second auxiliary power output 194. The various outputs may or may not be able to be produced all at the same time, depending on the capacity of the engine 200 and the generator 190 and the particular design of the welding power supply 210. For example, in one embodiment, the first and second auxiliary power outputs 192 and 194 may be able to be produced at the same time. Similarly, the arc welding output 212 and the first and second auxiliary power outputs 192 and 194 may be able to be produced at the same time. Other combinations of simultaneous outputs are possible as well, in accordance with other embodiments. To be clear, the various outputs (arc welding output 212, first auxiliary output 192, second auxiliary output 194) as discussed herein refer to electrical signals (e.g., an arc welding current and voltage, an alternating current and voltage, a direct current and voltage), not to, for example, physical connector outputs on the EDWS 100.

The controller 220 puts the welding power supply 210 in one or more of the various modes (e.g., an arc welding mode) based on user selections via the user interface 230 and any system limitations (e.g., maybe can't select an arc welding mode and another mode at the same time). As seen in FIG. 6, the controller 220 interfaces to and controls at least the engine 200, the clutch assembly (or electric motor) 120, the air compressor subsystem 105, the welding power supply 210, and the user interface 230. In another embodiment, the controller 220 may also control the generator 190. In one embodiment, a tool 500 uses compressed air. A compressed air output 107 (i.e., compressed air produced by the air compression subsystem 105) is supplied to the tool 500 from the air compressor subsystem 105. The tool 500 may be, for example, a nail gun or a jack hammer.

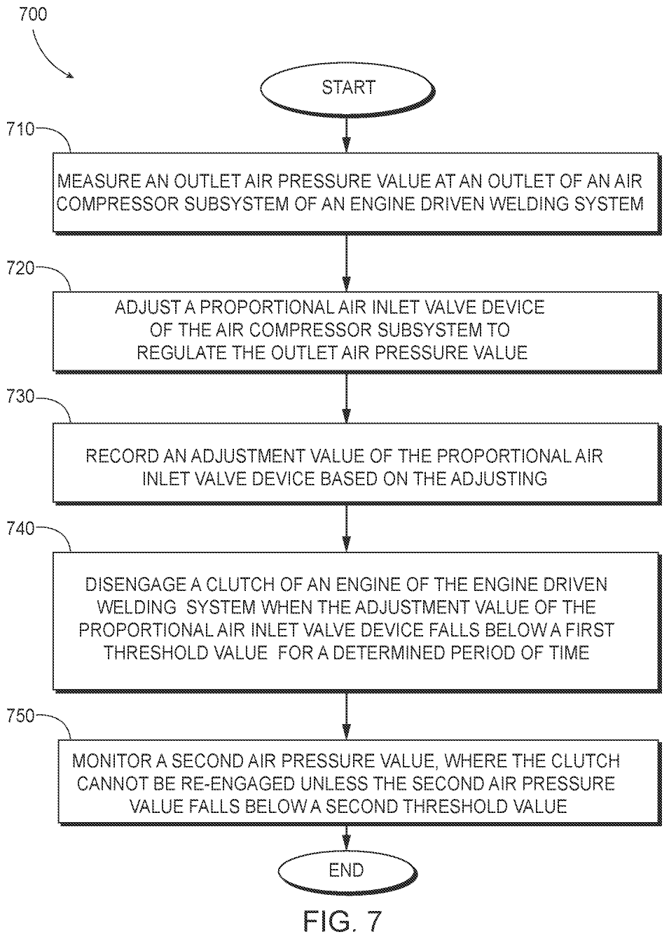

FIG. 7 illustrates a flowchart of one embodiment of a method 700 performed by the EDWS 100 of FIGS. 1-6. At block 710 of the method 700, an outlet air pressure value at an outlet of an air compressor subsystem 105 of an engine driven welding system 100 is measured. For example, in one embodiment, the outlet air pressure sensor 150 (a first air pressure sensor) measures the outlet air pressure value and reports the value to the controller 220. At block 720, a proportional air inlet valve device 130 of the air compressor subsystem 105 is adjusted (the valve of the valve device is open/closed by some amount) to regulate the outlet air pressure value to some desired value (i.e., the controller 220 adjusts the proportional air inlet valve device 130 depending on the difference of the outlet air pressure value versus a set point pressure value). Such adjusting results in less fluctuation of the outlet pressure.

At block 730, an adjustment value (how much the valve of the valve device is open/closed) of the proportional air inlet valve device 130 is recorded based on the adjusting. For example, in one embodiment, a controller (e.g., the controller 220) is configured to control the proportional air inlet valve device 130 and record the adjustment value of the proportional air inlet valve device 130 as adjusted. For example, in one embodiment, the proportional air inlet valve device 130 includes a solenoid valve which is controlled by the controller 220.

At block 740 of the method 700, a clutch (of the clutch assembly 120) of the engine driven welding system 100 is disengaged when the adjustment value of the proportional air inlet valve device 130 falls below a first threshold value for a determined period of time. For example, in one embodiment, when the adjustment value falls below 5% open for 5 minutes, the clutch is disengaged. That is, the pressurized air is where it needs to be and additional air compression is not required, so the clutch can be disengaged. At block 750, a second air pressure value is monitored and the clutch cannot be re-engaged unless the second air pressure value falls below a second threshold value. For example, in one embodiment, the second air pressure value is a sump pressure value measured by the sump pressure sensor 140 of the air compressor subsystem 105. The sump pressure sensor 140 is located proximate the oil/gas separator device 112 of the air compressor subsystem 105.

In one embodiment, the controller 220 is configured to stop the engine 200 of the engine driven welding system 100 when conditions indicate inactivity over a second determined period of time. The controls (e.g., the controller 220) remain powered up and, if the outlet pressure decreases by a certain amount, the engine 200 is restarted. For example, in one embodiment, after 15 minutes of inactivity (e.g., no welding output use, no air compression output use, and no auxiliary power output use) the controller 220 may be programmed to stop the engine 200. If the engine 220 has not restarted after an extended time period, the controls are then shut down and the EDWS 100 must be manually restarted, in accordance with one embodiment.

In one embodiment, the controller 220 is configured to vary a speed of the engine 200 of the engine driven welding system 100 based on a demand of the air compressor subsystem 105. For example, as demand of the air compressor subsystem 105 increases, the controller 220 may increase the speed of the engine, and vice versa. Such control allows for variable speed operation to increase fuel efficiency and to lower sound and emissions. In accordance with one embodiment, if the proportional air inlet valve device 130 is remaining closed (or mostly closed) for a certain amount of time, the engine revolutions per minute (rpm) is slowly decreased until the inlet valve device 130 is open (or mostly opened). If the amount that the inlet valve device 130 is open exceeds a threshold over time, the engine rpm is slowly increased until the target inlet valve opening is achieved.

In one embodiment (when the EDWS 100 is running both a weld load and the air compressor subsystem) the controller 220 is configured to monitor a bus voltage to a weld circuit within the welding power supply 210 of the engine driven welding system 100 and command the air compressor subsystem 105 to reduce air output (including disengaging the clutch assembly 120, if necessary) when the bus voltage drops below a bus voltage threshold value. The air compressor output is returned to the set point value only once the controller 220 determines that the weld load has dropped by a given level for a certain amount of time.

Similarly, in one embodiment, (when the EDWS 100 is running both an auxiliary load and the air compressor) the controller 220 is configured to monitor an electrical parameter of an auxiliary power output (192 and/or 194) provided by the engine driven welding system 100 and command the air compressor subsystem 105 to reduce air output (including disengaging the clutch assembly 120, if necessary) when the electrical parameter drops below an associated threshold value. For example, the electrical parameter may be a voltage, a current, a power, or a frequency of the auxiliary power output. The air compressor output is returned to the set point value only once the controller 220 determines that a measured value of the electrical parameter is above a given level for a certain amount of time.

FIG. 8 illustrates a block diagram of an example embodiment of a controller 800 that can be used in the EDWS 100 of FIGS. 1-6. For example, in accordance with one embodiment, the controller 800 (or a least portions thereof) serves as the controller 220 in FIG. 5 and FIG. 6 herein. In other embodiments, the controller 800 (or portions thereof) may be used in or distributed among one or more of the engine 200, the generator 190, the air compressor subsystem 105, the welding power supply 210, and the user interface 230. For example, in one embodiment, the controller 800 (or a least portions thereof) serves as the controller 220 in FIG. 5 and FIG. 6 herein, and one or more of the engine 200, the generator 190, the air compressor subsystem 105, the welding power supply 210, or the user interface 230 also include one or more components of the controller 800. In this manner, multiple elements of the EDWS 100 may include at least some level of control capability.

Referring to FIG. 8, the controller 800 includes at least one processor 814 (e.g., a central processing unit, a graphics processing unit) which communicates with a number of peripheral devices via bus subsystem 812. These peripheral devices may include a storage subsystem 824, including, for example, a memory subsystem 828 and a file storage subsystem 826, user interface input devices 822, user interface output devices 820, and a network interface subsystem 816. The input and output devices allow user interaction with the controller 800. Network interface subsystem 816 provides an interface to outside networks and is coupled to corresponding interface devices in other devices.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into the controller 800 or onto a communication network.

User interface output devices 820 may include a display subsystem, a printer, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from the controller 800 to the user or to another machine or computer system.

Storage subsystem 824 stores programming and data constructs that provide some or all of the functionality described herein. For example, computer-executable instructions and data are generally executed by processor 814 alone or in combination with other processors. Memory 828 used in the storage subsystem 824 can include a number of memories including a main random access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The computer-executable instructions and data implementing the functionality of certain embodiments may be stored by file storage subsystem 826 in the storage subsystem 824, or in other machines accessible by the processor(s) 814.

Bus subsystem 812 provides a mechanism for letting the various components and subsystems of the controller 800 communicate with each other as intended. Although bus subsystem 812 is shown schematically as a single bus, alternative embodiments of the bus subsystem may use multiple buses.

The controller 800 can be of varying types. Due to the ever-changing nature of computing devices and networks, the description of the controller 800 depicted in FIG. 8 is intended only as a specific example for purposes of illustrating some embodiments. Many other configurations of the controller are possible, having more or fewer components than the controller 800 depicted in FIG. 8.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or illustrative examples shown and described. Thus, this disclosure is intended to embrace alterations, modifications, and variations that fall within the scope of the appended claims, which satisfy the statutory subject matter requirements of 35 U.S.C. § 101. The above description of specific embodiments has been given by way of example. From the disclosure given, those skilled in the art will not only understand the general inventive concepts and attendant advantages, but will also find apparent various changes and modifications to the structures and methods disclosed. It is sought, therefore, to cover all such changes and modifications as fall within the spirit and scope of the general inventive concepts, as defined by the appended claims, and equivalents thereof.

What is claimed is:

1. An engine driven welding system having an air compressor subsystem, the system comprising:
an air compressor;
a first air pressure sensor configured to measure an outlet air pressure value at an outlet of the air compressor subsystem;
a proportional air inlet valve device configured to be adjusted to regulate the outlet air pressure value;
at least one controller configured to record an adjustment value of the proportional air inlet valve device as adjusted;
a clutch assembly configured to be engaged to enable air compression, and configured to be disengaged by the at least one controller when the adjustment value of the proportional air inlet valve falls below a first threshold value for a determined period of time; and
a second air pressure sensor configured to monitor a second air pressure value, where the clutch assembly cannot be re-engaged by the at least one controller unless the second air pressure value falls below a second threshold value.

2. The system of claim 1, further comprising an oil/gas separator device, wherein the second air pressure sensor is mounted proximate the oil/gas separator device.

3. The system of claim 1, wherein the proportional air inlet valve device includes a solenoid valve.

4. The system of claim 1, wherein the at least one controller is configured to control the proportional air inlet valve device.

5. The system of claim 1, wherein the at least one controller is configured to stop an engine of the engine driven welding system when conditions indicate inactivity over a second determined period of time.

6. The system of claim 1, wherein the at least one controller is configured to vary a speed of an engine of the engine driven welding system based on a demand of the air compressor subsystem.

7. The system of claim 1, wherein the at least one controller is configured to monitor a bus voltage to a weld circuit of the engine driven welding system and command the air compressor subsystem to reduce air output when the bus voltage drops below a bus voltage threshold value.

8. The system of claim 1, wherein the at least one controller is configured to monitor an electrical parameter of an auxiliary power provided by the engine driven welding system and command the air compressor subsystem to reduce air output when the electrical parameter drops below an associated threshold value.

9. The system of claim 8, wherein the electrical parameter is a voltage or a current.

10. The system of claim 8, wherein the electrical parameter is a frequency or a power.

11. A method of operating an air compressor subsystem of an engine driven welding system, the method comprising:
measuring an outlet air pressure value at an outlet of an air compressor subsystem of an engine driven welding system;
adjusting a proportional air inlet valve device of the air compressor subsystem to regulate the outlet air pressure value;
recording an adjustment value of the proportional air inlet valve device based on the adjusting;
disengaging a clutch of an engine of the engine driven welding system when the adjustment value of the proportional air inlet valve device falls below a first threshold value for a determined period of time; and
monitoring a second air pressure value, wherein the clutch cannot be re-engaged unless the second air pressure value falls below a second threshold value.

12. The method of claim 11, wherein the second air pressure value is monitored proximate an oil/gas separator device of the air compressor subsystem.

13. The method of claim 11, wherein the proportional air inlet valve device includes a solenoid valve.

14. The method of claim 11, wherein the proportional air inlet valve device is controlled by a controller.

15. The method of claim 11, further comprising stopping an engine of the engine driven welding system when conditions indicate inactivity over a second determined period of time.

16. The method of claim 11, further comprising varying a speed of an engine of the engine driven welding system based on a demand of the air compressor subsystem.

17. The method of claim 11, further comprising monitoring a bus voltage to a weld circuit of the engine driven welding system and commanding the air compressor subsystem to reduce air output when the bus voltage drops below a bus voltage threshold value.

18. The method of claim 11, further comprising monitoring an electrical parameter of an auxiliary power provided by the engine driven welding system and commanding the air compressor subsystem to reduce air output when the electrical parameter drops below an associated threshold value.

19. The method of claim 18, wherein the electrical parameter is a voltage or a current.

20. The method of claim 18, wherein the electrical parameter is a frequency or a power.
